(19) United States
(12) Patent Application Publication
(10) Pub. No.: US 2024/0190711 A1
(43) Pub. Date: Jun. 13, 2024

(54) SILICA MATERIAL AND METHOD OF MANUFACTURE AND SILICON DERIVED THEREFROM

(71) Applicant: ionobell, Inc., San Jose, CA (US)

(72) Inventors: Robert C. Ionescu, San Jose, CA (US); Chueh Liu, San Jose, CA (US)

(73) Assignee: ionobell, Inc., San Jose, CA (US)

(21) Appl. No.: 18/584,207

(22) Filed: Feb. 22, 2024

Related U.S. Application Data
(63) Continuation of application No. 18/101,389, filed on Jan. 25, 2023, now abandoned.
(60) Provisional application No. 63/302,726, filed on Jan. 25, 2022.
(60) Provisional application No. 63/399,119, filed on Aug. 18, 2022.

(51) Int. Cl. C01B 33/025; C01B 33/18

(52) U.S. Cl. CPC C01B 33/025; C01B 33/181; C01P 2002/02; C01P 2004/32; C01P 2004/61; C01P 2004/62; C01P 2006/80

(57) ABSTRACT

A method can include reducing a silica starting material to produce a first quantity of at least metallurgical grade silicon and a second quantity of silica comprising elemental carbon doping, wherein the silica starting material is reduced in the presence of a carbonaceous reducing agent. A silica material can be a silica material as prepared according to the method.

### CROSS-REFERENCE TO RELATED APPLICATIONS

This application is a divisional of U.S. patent application Ser. No. 18/101,389 filed 25 Jan. 2023 which claims the benefit of U.S. Provisional Application No. 63/399,119 filed 18 Aug. 2022 and U.S. Provisional Application No. 63/302,726 filed 25 Jan. 2022, each of which is incorporated in its entirety by this reference.

### TECHNICAL FIELD

This invention relates generally to the silicon particle field, and more specifically to a new and useful system and method in the silicon particle field.

### BRIEF DESCRIPTION OF THE FIGURES

FIGS. 1A-1D are schematic representations of exemplary silicon particles.

FIG. 2 is a schematic representation of an exemplary silicon material.

FIG. 3 is a schematic representation of the method.

FIGS. 4A-4C are schematic representations of examples of the method.

FIG. 5 is a schematic representation of an example of a carbothermal reaction.

FIG. 6 is a schematic representation of an example of reducing silica particles to silicon particles.

FIG. 7 is a schematic representation of an example of a furnace reducing a silica starting material with exemplary thermal and species (e.g., silica, silicon) concentration gradients.

FIGS. 8A-8C are schematic representations of exemplary particle size distributions for silica particles (e.g., silica particles recovered during S200, silica particles used in S300, etc.) and/or silicon particles (e.g., resulting from S300).

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

The silicon material can include one or more particles, where each particle can include silicon, dopants, stabilizing agents, and/or any suitable elements or materials.

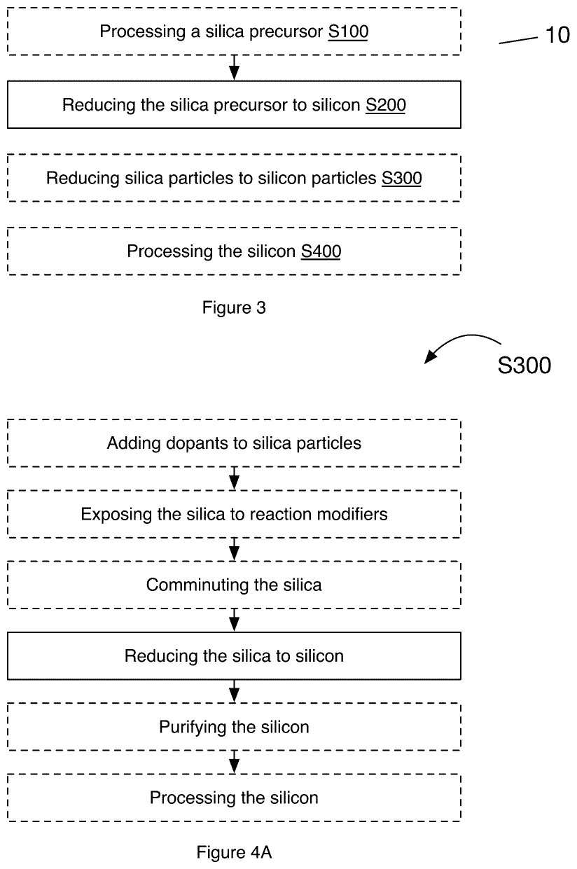

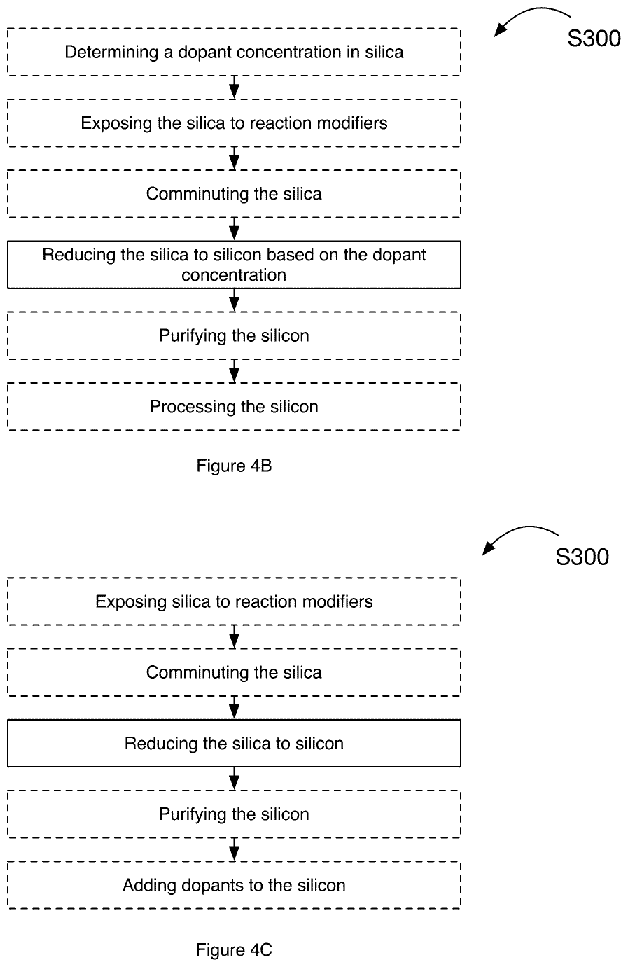

As shown in FIG. 3, the method can include reducing a silica precursor. The manufacturing method can optionally include processing the silica precursor, processing the silicon, and/or any suitable steps. In various examples, as shown for example in FIGS. 4A-4C, reducing the silicon can include: exposing the silica precursor to one or more reaction modifiers, comminuting the silica precursor, purifying the silicon, and/or any suitable step(s).

The silicon material is preferably used as (e.g., included in) an anode material (e.g., an anode slurry) in a battery (e.g., a Li-ion battery). However, the silicon material can additionally or alternatively be used for photovoltaic applications (e.g., as a light absorber, as a charge separator, as a free carrier extractor, etc.), as a thermal insulator (e.g., a thermal insulator that is operable under extreme conditions such as high temperatures, high pressures, ionizing environments, low temperatures, low pressures, etc.), for high sensitivity sensors (e.g., high gain, low noise, etc.), as a radar absorbing material, as insulation (e.g., in buildings, windows, thermal loss and solar systems, etc.), for biomedical applications, for pharmaceutical applications (e.g., drug delivery), as an aerogel or aerogel substitute (e.g., silicon aerogels), and/or for any suitable application. For some of these applications, including but not limited to the pharmaceutical applications, the silicon material can be oxidized into silica (e.g., SiO₂ that retains a morphology substantially identical to that of the silicon material) and/or used as silicon.

### 2. Benefits

Variations of the technology can confer several benefits and/or advantages.

First, variants of the technology can enable large internal surface area (e.g., porous interior, Brunauer-Emmett-Teller (BET) surface area of the internal surfaces that is greater than about 10 m²/kg, surface that is not directly exposed to the external environment, configured to achieve a low external silicon expansion such as less than 50% expansion, configured to enable expansion into a void space within the internal volume, etc.) and low external surface area (e.g., surface that is directly exposed to the external environment, BET surface area is less than about 150 m²/kg, measured BET for the particle is less than about 150 m²/kg, etc.) silicon material. In a specific example, the preparation of carbon dopants within silica precursor can lead to local heating effects and/or local hot spots which can melt and/or fuse the silicon material thereby influencing the surface areas (e.g., internal and/or external), morphology, and/or other properties of the silicon material and/or process of forming said material.

Second, variants of the technology can introduce dopants which can impact (e.g., increase, decrease) a conductivity (e.g., electron conductivity, ion conductivity, etc.)

of the silicon material. Similarly, the inclusion of dopants can modify (e.g., inhibit, promote, etc.) the formation of and/or extent of silicon crystallization (e.g., promote the formation of amorphous silicon, promote the formation of crystalline silicon, etc.). The introduction of these dopants into precursors used to the manufactured of the silicon (e.g., from silica) can be beneficial for simplifying the silicon processing (e.g., alleviating a need to dope the silicon, improving a dopant distribution in the silicon, etc.), for modifying the silicon morphology as derived from the precursor (e.g., because the dopants can have different thermal conductivity, heat capacity, or other thermal properties which can result for instance in local hot or cold spots), and/or can otherwise be beneficial.

Third, variants of the technology can enable silica fumes (or other silica materials) to be manufactured with larger characteristic sizes. For instance, in some variants, the silica material (e.g., silica fumes) can have characteristic size between 500 nm and 5 μm (as opposed to 2-100 nm as is more frequently formed). The increased size can be enabled by using higher temperatures, higher pressures, the presence of greater amounts carbon (e.g., using excesses of carbon relative to the silica), by modifying a temperature of a collection region of the furnace, and/or can otherwise be enabled.

Fourth, variants of the technology can facilitate doping of the silica (e.g., silica fumes) with carbon (e.g., to achieve a target doping concentration). For example, the method can increase doping of the silica with carbon by not washing the furnace between instances of reducing silica precursors (e.g., washing the furnace in a manner that removes metals but not carbon from interior surfaces such as using acids, chelating agents, etc.) as carbon remaining on the furnace between runs can be trapped within the silica fumes.

However, variants of the technology can confer any other suitable benefits and/or advantages.

### 3. Silicon Material

The silicon material is preferably the result of reducing a silica material (e.g., a silica material as produced in the method such as in S200, such as according to the method process S300, etc.). However, the silicon material can be any suitable silicon material. The silicon material can include one or more particles, where each particle can include silicon, dopants, stabilizing agents, and/or any suitable elements or materials. The silicon material can function as (e.g., be used for) energy storage (e.g., as a material for a battery anode), for photovoltaic applications, as a thermal insulator, for material absorption and/or release, as an aerogel, and/or can otherwise function.

The silicon material is preferably majority silicon (e.g., at least about 50% Si such as 60%, 65%, 70%, 75%, 80%, 90%, 95%, 97.5%, 99%, 99.9%, 85-93%, 50-95%, 80-95%, values or ranges therebetween, etc.). The silicon concentration (e.g., as a percentage) of the silicon material can refer to a mass percent, purity percent, volume percent, stoichiometric ratio (e.g., stoichiometric percent), and/or any suitable percentage. However, the silicon material can be a plurality silicon (e.g., more silicon than any other constituent but not greater than 50% silicon), and/or have any suitable silicon concentration.

The silicon material (and/or free silicon thereof) can be amorphous, crystalline (e.g., polycrystalline, monocrystalline, pseudocrystalline, etc.), and/or have any suitable structure. In a specific example, the silicon material (or particles thereof) can include regions that are amorphous and crystalline regions. In related examples, the crystallinity can be influenced (e.g., controlled by) the presence (and/or absence) of, the identity of (e.g., type), the concentration of (e.g., local concentration, average concentration, etc.), and/or any suitable property of the dopants, stabilizing agents, impurities, and/or other constituents. As an illustrative example, the inclusion of carbonaceous dopants can led to regions of and/or a greater degree of amorphous silicon.

The dopant(s) can function to modify a crystallinity of, modify (e.g., increase, decrease) a conductivity (e.g., thermal, electrical, ionic, atomic, etc. conductivity) of, modify (e.g., increase, decrease) a stability of the silicon material, can improve a formation of an SEI layer (e.g., when the material is used in a battery application), and/or can otherwise modify a property of the silicon material. The silicon material preferably includes at most about 45% of dopant (e.g., (e.g., 45%, 40%, 30%, 25%, 20%, 15%, 10%, 5%, 2%, 1%, 0.5%, 0.1%, 2-10%, etc.). However, the silicon material can additionally or alternatively include greater than 45% dopant. The dopant concentration can refer to a total dopant concentration (e.g., for all dopants when more than one dopant is included), a dopant concentration for a particular dopant, and/or any suitable concentration. The concentration can be a mass concentration, purity, atomic, stoichiometric, volumetric, and/or any suitable concentration.

The dopant(s) are preferably crystallogens (also referred to as a Group 14 elements, adamantogens, Group IV elements, etc. such as carbon, germanium, tin, lead, etc.). However, the dopant(s) can additionally or alternatively include: chalcogens (e.g., oxygen, sulfur, selenium, tellurium, etc.), pnictogens (e.g., nitrogen, phosphorous, arsenic, antimony, bismuth, etc.), Group 13 elements (also referred to as Group III elements such as boron, aluminium, gallium, indium, thallium, etc.), halogens (e.g., fluorine, chlorine, bromine, iodine, etc.), alkali metals (e.g., lithium, sodium, potassium, rubidium, caesium, etc.), alkaline earth metals, transition metals, lanthanides, actinides, and/or any suitable materials.

The dopants can be interstitial dopants (e.g., occupy interstitial sites), substitutional dopants (e.g., replace an atom within a lattice or other structure), surface dopants (e.g., occupy surface locations), and/or any suitable dopants.

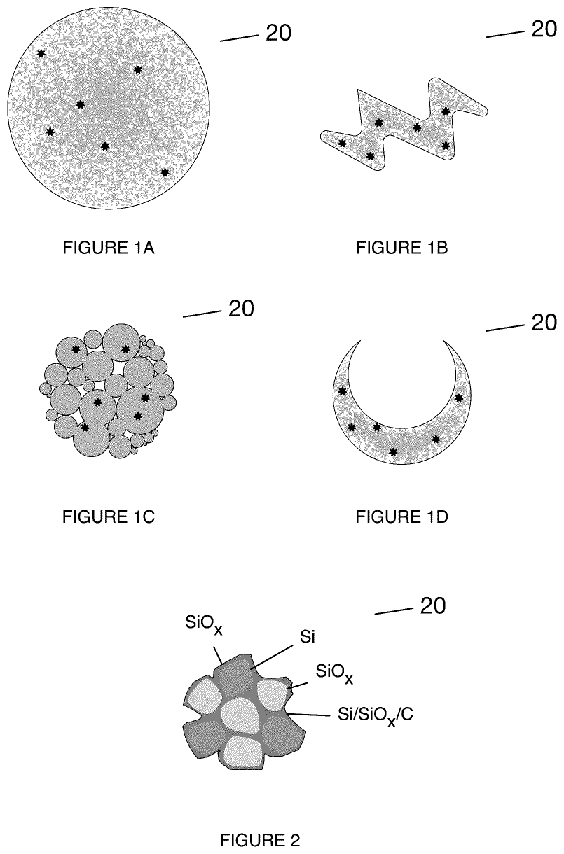

The dopants can be homogeneously distributed (e.g., as shown for example in FIGS. 1A-1D) and/or heterogeneously distributed (e.g., as shown for example in FIG. 2). Examples of heterogeneous distributions can include: greater dopant concentrations proximal an external surface of the silicon material, great dopant concentrations distal an external surface of the silicon material (e.g., greater concentration within the center or central region of the silicon material), a patterned dopant distribution (e.g., a radial distribution, a an azimuthal distribution, with a distribution that depends on a particle shape and/or a target particle shape, etc.), and/or any suitable inhomogeneous distribution. In variants, the dopants can be distributed in the same (e.g., collocated with, have a similar distribution profile as, etc.) or different (e.g., have a different distribution profile from) manner as stabilizing agents.

The silicon material can include one or more dopant type (e.g., two dopants, three dopants, four dopants, five dopants, ten dopants, etc.) and/or any suitable dopants.

The stabilizing agent(s) preferably function to increase a stability (e.g., chemical stability to resist chemical wear; mechanical stability to resist mechanical wear; cyclability of the silicon material to expansion/contraction, charging/discharging, and/or other cyclable processes; etc.) of the silicon material. The stabilizing agent(s) can additionally or alternatively modify an electrical (e.g., capacity) or other property of the silicon material, and/or can otherwise function. The stabilizing agent is typically different from the dopant, but can be the same as the dopant.

The stabilizing agent is preferably oxygen (e.g., forming silicon oxides within the silicon material), but can additionally or alternatively include other chalcogens (e.g., sulfur, selenium, tellurium, polonium, etc.), pnictogens (e.g., nitrogen, phosphorous, arsenic, antimony, bismuth, etc.), and/or any suitable elements and/or molecules (e.g., one or more dopants materials).

The stabilizing agent concentration (e.g., mass concentration, volume concentration, stoichiometric concentration, etc.) in the silicon material is preferably at most 50% (e.g., 0%, 1%,2%, 5%, 10%, 20%, 25%, 30%, 40%, 50%, values therebetween, etc.), but can be greater than 50%. The stabilizing agent concentration can refer to a total stabilizing agent concentration (e.g., for all stabilizing agents when more than one stabilizing agent is present), a specific stabilizing agent concentration (e.g., for a particular stabilizing agent), and/or any suitable concentration.

The stabilizing agents are typically inhomogeneously distributed within the silicon material, but can be homogeneously distributed and/or distributed in any manner. In a first illustrative example, a particle of the silicon material can include one or more grains (e.g., with a grain size between about 10 nm and 10 μm; with a grain size that depends on a size of the particle, cluster, agglomer, etc.; etc.) that include stabilizing agent and one or more grains (e.g., with a grain size between about 10 nm and 10 μm; with a grain size that depends on a size of the particle, cluster, agglomer, etc.; etc.) that are devoid of the stabilizing agent. In a second illustrative example, a first particle of the silicon material can include stabilizing agent and a second particle of the silicon material can be substantially devoid of (e.g., include less than a threshold amount such as less than 1%, 5%, etc. of; have no detectable; etc.) stabilizing agent. In a third illustrative example, the stabilizing agent can have a greater concentration proximal (e.g., within a threshold distance such as 0.1, 0.5, 1, 2, 5, 10, 20, 50, etc. nanometers of) an exposed (e.g., to an external environment, to an internal void space, etc.) surface of the silicon material than proximal a central region (e.g., a region greater than a threshold distance from the exposed surface) of the silicon material. In a variation of the third illustrative example, a gradient of stabilizing agent can be present, for instance with a decreasing stabilizing agent concentration as the distance from an exposed surface of the silicon material increases. In a fourth illustrative example, any or all of the first through third illustrative examples can be combined. However, the stabilizing agent can be distributed in any manner.

An external expansion (e.g., volumetric expansion, areal expansion, linear expansion along one more directions, etc. such as resulting from lithiation, thermal expansion, metalation, etc.) of the silicon material (and/or particles thereof) is preferably less than about 50% (e.g., compression such as a negative expansion, 0%, 5%, 10%, 20%, 30%, 40%, 50%, values or ranges therebetween, etc.), but can be greater than 50%. The external expansion can be achieved, for instance, by enabling internal expansion (e.g., an internal void space) within the silicon material where the silicon material can expand internally (e.g., before, in addition to, in the alternative to, etc. expanding externally such as into an external environment proximal the silicon material). However, the external expansion can otherwise be achieved (e.g., by modifying a lattice constant, density, or other properties of the silicon material).

The surface area of the exterior surface of the silicon material (e.g., an exterior surface of the particles, an exterior surface of a cluster of particles, an exterior surface of an agglomer of particles and/or clusters, etc.) is preferably small (e.g., less than about 0.01, 0.5 m²/g, 1 m²/g, 2 m²/g, 3 m²/g, 5 m²/g, 10 m²/g, 15 m²/g, 20 m²/g, 25 m²/g, 30 m²/g, 50 m²/g, values or between a range thereof), but can be large (e.g., greater than 10 m²/g, 15 m²/g, 20 m²/g, 25 m²/g, 30 m²/g, 50 m²/g, 75 m²/g, 100 m²/g, 110 m²/g, 125 m²/g, 150 m²/g, 175 m²/g, 200 m²/g, 300 m²/g, 400 m²/g, 500 m²/g, 750 m²/g, 1000 m²/g, 1250 m²/g, 1400 m²/g, ranges or values therebetween, >1400 m²/g) and/or any suitable value.

The surface area of the interior of the silicon material (e.g., a surface exposed to an internal environment that is separated from with an external environment by the exterior surface, a surface exposed to an internal environment that is in fluid communication with an external environment across the exterior surface, interior surface, etc. such as within a particle, cooperatively defined between particles, between clusters of particles, between agglomers, etc.) is preferably large (e.g., greater than 10 m²/g, 15 m²/g, 20 m²/g, 25 m²/g, 30 m²/g, 50 m²/g, 75 m²/g, 100 m²/g, 110 m²/g, 125 m²/g, 150 m²/g, 175 m²/g, 200 m²/g, 300 m²/g, 400 m²/g, 500 m²/g, 750 m²/g, 1000 m²/g, 1250 m²/g, 1400 m²/g, ranges or values therebetween, >1400 m²/g), but can be small (e.g., less than about 0.01, 0.5 m²/g, 1 m²/g, 2 m²/g, 3 m²/g, 5 m²/g, 10 m²/g, 15 m²/g, 20 m²/g, 25 m²/g, 30 m²/g, 50 m²/g, values or between a range thereof). However, the surface area of the interior can be above or below the values above, and/or be any suitable value.

The shape of the particles can be spheroidal (e.g., spherical, ellipsoidal, as shown for example in FIG. 1A or 1C, etc.); rod; platelet; star; pillar; bar; chain; flower; reef; whisker; fiber; box; polyhedron (e.g., cube, rectangular prism, triangular prism, etc.); have a worm-like morphology (as shown for example in FIG. 1B, vermiform, etc.); have a foam like morphology; have an egg-shell morphology; have a shard-like morphology (e.g., as shown for example in FIG. 1D); and/or have any suitable morphology. The particles can be freestanding, clustered, aggregated, agglomerated, interconnected, and/or have any suitable relation or connection(s).

The particles can be nanoparticles, microparticles, mesoparticles, macroparticles, and/or any suitable particles. The particles can be discrete and/or connected. In variations, the particles can form clusters, aggregates, agglomers, and/or any suitable structures (e.g., higher order structures). A characteristic size of the particles is preferably between about 1 nm to about 2000 nm such as 2 nm, 5 nm, 10 nm, 20 nm, 25 nm, 30 nm, 50 nm, 75 nm, 100 nm, 125 nm, 150 nm, 175 nm, 200 nm, 250 nm, 300 nm, 400 nm, 500 nm, 1000 nm, or 1500 nm. However, the characteristic size can additionally or alternatively be less than about 1 nm and/or greater than about 2000 nm. In specific examples, the characteristic size can include the radius, diameter, circumference, longest dimension, shortest dimension, length, width, height, pore size, a shell thickness, and/or any size or dimension of the particle. The characteristic size of the particles is preferably distributed on a size distribution. The size distribution can be a substantially uniform distribution (e.g., a box distribution, a mollified uniform distribution, etc. such that the number of particles or the number density of particles with a given characteristic size is approximately constant), a Weibull distribution, a normal distribution, a log-normal distribution, a Lorentzian distribution, a Voigt distribution, a log-hyperbolic distribution, a triangular distribution, a log-Laplace distribution, and/or any suitable distribution.

The particles can be solid, hollow, porous, as shown for example in FIGS. 1A-1D, and/or have any structure.

In a specific example, the silicon material can have a structure and/or composition that is substantially the same as that described for a silicon material disclosed in U.S. patent application Ser. No. 17/322,487 titled ‘POROUS SILICON AND METHOD OF MANUFACTURE’ and filed 17 May 2021, U.S. patent application Ser. No. 17/525,769 titled ‘SILICON MATERIAL AND METHOD OF MANUFACTURE’ filed 12 Nov. 2021, or U.S. patent application Ser. No. 17/990,463 titled ‘SILICON MATERIAL AND METHOD OF MANUFACTURE’ filed 18 Nov. 2022, each of which is incorporated in its entirety by this reference. However, the silicon material can have any suitable structure.

In a second illustrative example, the silicon material can be or include porous carbon infused silicon, porous carbon decorated silicon structure, porous silicon carbon hybrid, a porous silicon carbon alloy, a porous silicon carbon composite, silicon carbon alloy, silicon carbon composite, carbon decorated silicon structure, carbon infused silicon, carborundum, silicon carbide, and/or any suitable allotrope or mixture of silicon, carbon, and/or oxygen. For instance, the elemental composition of the silicon material can include SiOC, SiC, SiₓOₓC, SiₓOₓC_{y}, SiOₓC_{y}, SiₓC_{y}, SiOₓ, SiₓO_{y}, SiO₂C, SiO₂Cₓ, SiOCZ, SiCZ, SiₓO_{y}CZ, SiₓOₓCₓZₓ, SiₓCₓZ_{y}, SiOₓZₓ, SiₓOₓZ_{y}, SiO₂CZ, SiO₂CₓZ_{y}, and/or have any suitable composition (e.g., include additional element(s)), where Z can refer to any suitable element of the periodic table and x and/or y can be the same or different and can each be between about 0.001 and 2 (e.g., 0.001, 0.005, 0.01, 0.05, 0.1, 0.5, 1, 2, 0.001-0.05, 0.01-0.5, 0.01-0.1, 0.001-0.01, 0.005-0.1, 0.5-1, 1-2, values or ranges therebetween etc.), less than 0.001, or greater than 2. The silicon material can be homogeneous or heterogeneous. In a first variation, the silicon material can include a homogeneous mixture of particles (e.g., each particle has a similar composition), where each particle can be a composite, homogeneous mixture, heterogenous mixture, and/or any suitable composition of silicon, carbon, and oxygen (e.g., SiOC, SiOₓCₓ, SiOCₓ, etc.). In a second variation, the silicon material can include an inhomogeneous mixture of particles (e.g., particles can have different compositions). However, the silicon material can include any suitable composition.

In a third illustrative example, the silicon material can include hollow particles with a characteristic size (e.g., diameter, principal diameter, average diameter, etc.) between about 1-10 μm, an internal surface area greater than about 25 m²/g (e.g., 50 m²/g, 75 m²/g, 100 m²/g, 150 m²/g, 200 m²/g, 250 m²/g, 300 m²/g, 500 m²/g, 1000 m²/g, values or ranges therebetween, etc.), and an external surface area less than about 50 m²/g (e.g., <0.1 m²/g, 0.1 m²/g, 0.5 m²/g, 1 m²/g, 2 m²/g, 5 m²/g, 10 m²/g, 20 m²/g, 25 m²/g, values or ranges therebetween, etc.). In some variations of the third illustrative example, the internal surface area is less than about 500 m²/g, which can be beneficial for minimizing an extent of oxidation (e.g., formation of surface oxide) that can occur and/or can require less stringent environmental conditions for handling the silicon material (e.g., prior to sealing the interior surface area, elemental composition of an environment trapped within the hollow cavity, etc.). In these examples, the external surface area can be measured using: direct measurements (e.g., determining a bulk volume and a volume of the skeletal material without pores), nitrogen absorption, intrusion porosimetry (e.g., mercury-intrusion porosimetry), computed tomography, optical methods, water evaporation methods, gas expansion methods, thermoporosimetry, cryoporometry, direct imaging (e.g., SEM, TEM, STEM, etc.), density gradient ultracentrifugation, and/or using any suitable method(s). The internal surface area can be measured: in the same manner as the external surface area (e.g., by measuring the internal surface area prior to sealing, forming, etc. the external surface area, by etching or otherwise removing the external surface area to measure the internal surface area, etc.), using nuclear magnetic resonance (e.g., NMR such as evaluating, comparing, etc. a solvent relaxation time for solvent molecules in an interior vs exterior of the particles), based on an external expansion of the particle during metalation (e.g., expansion caused by lithium or other ion intercalation within the material), and/or using any suitable measurement or combination of measurements. However, the surface area (internal or external) can otherwise be determined.

### 4. Method

The method preferably functions to manufacture a silica material (e.g., which can be used to make a silicon material such as described above), but can function to manufacture any silica and/or silicon material. As shown in FIG. 3, the method can include reducing a silica precursor S200. The manufacturing method can optionally include processing the silica precursor S100, reducing silica particles S300, processing the silicon S400, and/or any suitable steps. In various examples, as shown for example in FIGS. 4A-4C, reducing the silicon particles S300 can include: exposing the silica precursor to one or more reaction modifiers S310, comminuting the silica precursor S320, purifying the silicon S330, and/or any suitable step(s). Steps of the method can be prepared in a continuous process (e.g., sequentially without significant delays between steps), in batches, in contemporaneous or simultaneous processes, using delayed processes, and/or with any suitable timing.

The method and/or steps thereof can be performed in a single chamber (e.g., a furnace, an oven, etc.) and/or in a plurality of chambers (e.g., a different chamber for each step or substep, a heating chamber, a coating chamber, a milling chamber, a washing chamber, etc.). The method can be performed on a laboratory scale (e.g., microgram, milligram, gram scale such as between about 1 μg and 999 g, etc.), manufacturing scale (e.g., kilogram, megagram, etc. such as between about 1 kg and 999 Mg), and/or any suitable scale.

When the silica material is used to make silicon, the resulting silicon can have substantially the same morphology and/or structure as the silica precursor (e.g., retain the same shape with a change in lattice constant and/or size commensurate with the change in lattice spacing between silica and silicon, be fused at points of contact between particles, have an identical appearance with the same or different size, etc.) and/or a different morphology and/or structure from the silica precursor (e.g., form shards, break, fuse, have different size or morphology, etc.). However, the resulting silicon can have any suitable morphology.

Processing the silica starting material S100 functions to prepare the silica starting material (sometimes referred to as a silica precursor, SiOₓ, etc.) for reduction. The silica starting material can be crystalline, amorphous, cryptocrystalline, pseudocrystalline, and/or have any suitable structure. The silica starting material preferably has a high purity (such as 90%, 95%, 98%, 99%, 99.5%, 99.9%, 99.99%, 99.995%, 99.999%, etc. where the percentage can refer to a mass percentage, volume percentage, stoichiometric percentage, etc.). However, the silica starting material can have a lower purity (e.g., where impurities can be removed via washing, where impurities can act as reducing agents, where impurities can be removed during reduction, etc.) and/or any suitable purity. Examples of silica starting materials include: sand, quartz, quartzite, coesite, cristobalite, keatite, moganite, seifertite, stishovite, tridymite, chalcedony, chert, flint, jasper, fulgurite, lechatelierite, opal, biogenic silica (e.g., diatomaceous earth, phytoliths, diatoms, etc.), recycled silica (e.g., recycled from glass containers, glass bottles, etc.), and/or any suitable silica starting material can be used.

The silica starting material can include: bulk silica, glass (e.g., glass shards), silica gel, silica powder, silica particles (e.g,. nanoparticles, mesoparticles, microparticles, macroparticles, sand grains such as with a diameter between 0.0625 and 2 mm, gravel grains such as with a diameter between 2 and 64 mm, silt grains such as with a diameter between 0.004 mm and 0.0625 mm, etc.), and/or combinations thereof. In some variants (particularly, but not exclusively when S200 may be excluded), the silica starting material can be porous silica with a diameter (e.g., most common diameter, mean diameters, topsize diameter, minimum diameter, etc.) or other characteristic dimension between 1 μm and 50 μm (e.g., 1 μm, 2 μm, 3 μm, 5 μm, 10 μm, 20 μm, 30 μm, 50 μm values or ranges therebetween, etc.). Variations with silica particles with a size comparable to graphite particles (e.g., silica particles with a particle size 10-30 μm, 3-5 μm, 3-30 μm, 3-10 μm, 5-30 μm, etc.) can provide particular technical advantages particularly in applications (e.g., batteries, battery anodes, etc.) that include a combination of graphite and silicon (e.g., silicon derived from the silica). In these variations, the silica particles can be obtained, for instance, by grinding quartz. In these variants, the silica starting material preferably has a with a narrow size (e.g., diameter) distribution such as a variance or standard deviation of the size distribution that is less than about 20% (e.g., 0.1%, 1%, 2%, 5%, 10%, 15%, 22%, etc.) of the mean of the size distribution (e.g., a size distribution with a mean size of 5 μm would have a standard deviation of at most 1 μm). However, the size distribution can be large and/or any suitable value. As a specific example, silica (e.g., sand, gravel grains, etc.) can be comminuted (e.g., using a grinder, ground, milled, etc.) to achieve these silica starting materials.

Processing the silica starting material can include one or more of washing the silica S110 (e.g., using one or more solvents, surfactants, acids, bases, etchants, etc.), doping the silica S120, determining a dopant concentration in the silica S130, exposing the silica to one or more reaction modifiers S140, and/or any suitable process.

Doping the silica precursor preferably functions to introduce and/or change an amount of one or more dopants in the silica. Doping the silica precursor is typically performed when dopants are not already present (e.g., at a threshold concentration, at a target concentration, from a prior processing step, from a manufacturing process, from the original silica source, etc.), but can be performed when dopants are already present in the silica precursor (e.g., to change an amount, identity, total number of, etc. dopants). Dopants can be introduced in the silica precursor via comminuting (e.g., milling the silica in the presence of one or more dopant), ion or atom implantation, coating, mixing, via diffusion, deposition, and/or using any suitable process. As an illustrative example, a silica precursor can be doped with carbon by ball milling the silica precursor with a carbon source (e.g., graphite, amorphous carbon, diamond, carbon nanotubes, coal, coke, polymers, etc.). However, the silica precursors can otherwise be doped.

The dopants can be distributed throughout the silica precursor (e.g., homogeneously distributed within particles, inhomogeneously distributed within particles, etc.), locally distributed within the silica precursor (e.g., proximal a center of silica particles, proximal a surface of silica particles, proximal an external environment, etc.), and/or otherwise be distributed within the silica precursor.

Determining a dopant concentration in the silica functions to determine (e.g., measure, detect, estimate, etc.) the amount, type, distribution of, and/or other properties of dopants within the silica precursor. The dopant properties (e.g., amount, type, distribution, etc.) can be used to modify (e.g., tune, set, etc.) the reduction of the silica precursor (e.g., to determine the reduction temperature, reducing agent, reducing agent concentration, temperature ramp, salt presence, salt concentration, reduction time, intermediate holding temperature(s), etc.) and/or can otherwise be used. For instance, a slower temperature ramp rate can be used for silica precursors with a higher carbon doping (because carbon can lead to hot spots and potentially thermal runway). However, the silica precursor can otherwise be processed based on the dopant properties.

The dopant properties can be measured using one or more of: simulations (e.g., calculations based on a model for the silica production process), a look-up table (e.g., relating the silica precursor source, production method, etc. to one or more dopant properties), energy-dispersive x-ray spectroscopy, electron energy loss spectroscopy, atomic spectroscopy, mass spectroscopy, optical spectroscopy, scanning electron microscopy, transmission electron microscopy, thermogravimetric analysis, scanning transmission electron microscopy, and/or using any suitable techniques. The dopant properties for more than one dopant can be determined contemporaneously, simultaneously, and/or at different times.

In a specific example, doping a silica precursor can include milling a silica precursor (e.g., silica fumes) with a carbon source (e.g., graphite, etc.). The silica precursor can be milled at a speed between about 1-2500 RPM, but can be milled at a speed less than 1 RPM and/or greater than 2500 RPM. The silica precursor can be milled for between about 1 min and 100 hours (e.g., 1 hour, 2 hours, 4 hours, 6 hours, 8 hours, 12 hours, 24 hours, etc.), but can be milled for less than 1 min and/or greater than 100 hours. This milling process can introduce carbon (and/or other dopants when other dopant sources are present, from the milling vessel, from the milling material, etc.) into the silica precursor, modify a silica precursor property (e.g., size, shape, morphology, porosity, etc.), and/or can other modify the silica precursor.

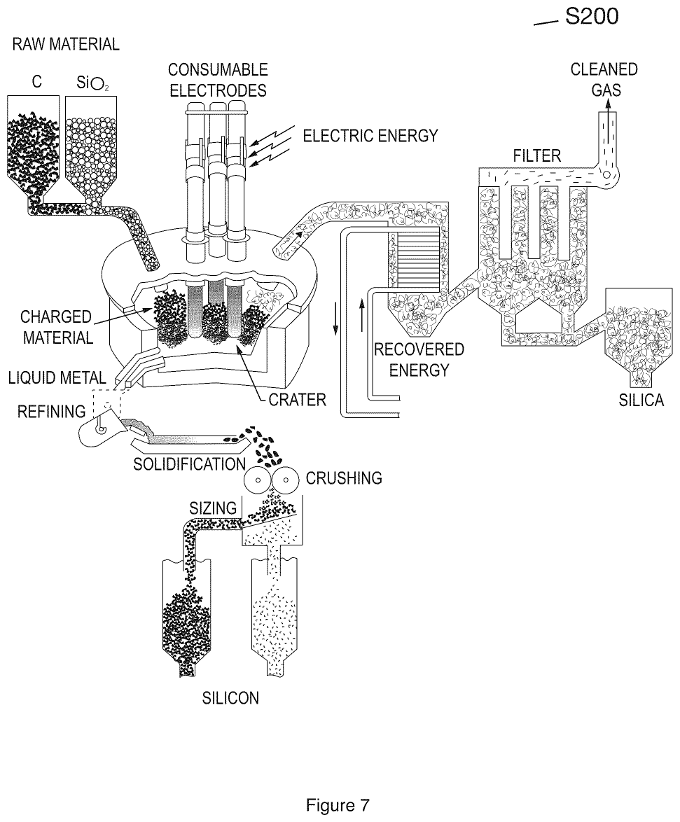

Reducing the silica starting material S200 preferably functions to reduce the silica starting material to a first quantity of a silicon material and a second quantity of silica material (e.g., residual silica material, captured silica material, etc.). S200 is preferably performed in a furnace (e.g., chamber). Examples of furnaces used in S200 can include electric arc furnace, smelting furnace, sintering furnace, muffle furnace, blast furnace, reverberatory furnace, and/or any suitable furnace. In a specific example, S200 can be performed in an electric arc furnace. However, S200 can be performed in any suitable reaction vessel. Typically, the first quantity of silicon and the second quantity of silica result from different subsets (e.g., where the subsets cannot be identified except in that different products form, subsets based on a region within the reduction chamber, based temperature distribution within the chamber, based on a reducing agent distribution within the chamber, as shown for example in FIG. 7, etc.) of the silica starting material (e.g., a first portion of the silica starting material forms the silicon and a second portion of the silica starting material forms such as via vaporization the silica). However, the first quantity of silicon and/or the second quantity of silica can result from the starting silica material (e.g., silica can be vaporized forming silica particles that are then reduced to form the silicon, silica can be reduced to silicon which can then be oxidized to form silica, etc.) and/or can otherwise be formed within the chamber.

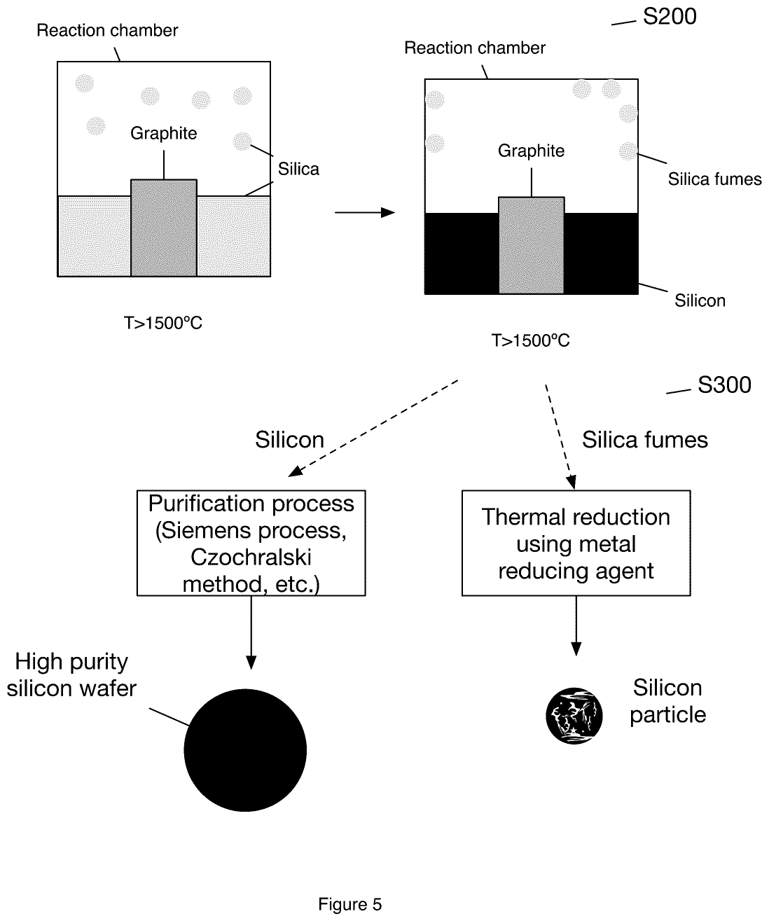

The first quantity of silicon material is preferably metallurgical grade silicon (e.g., silicon with an elemental purity between about 95-99.9% or values or ranges contained therein). However, the first quantity of silicon material can have a higher purity and/or lower purity. The first quantity of silicon material can undergo further purification processes (e.g., Siemens process, Czochralski method, zone melting, Bridgeman technique, etc. such as for use in solar applications, semiconductor applications, as shown for example in FIG. 5, etc.), be used for alloy production (e.g., aluminium-silicon alloys also called silumin, cast iron alloys such as ferrosilicon, calcium alloys such as silicocalcium alloys, steel making, etc.), can be reoxidized (e.g., by exposure to an oxidizing agent such as oxygen or water, heating in an oxidizing environment, etc. such as to be reused in the S200 process for the production of further silica particles), and/or can otherwise be used and/or processed. The first quantity of silicon material can be prepared as polycrystalline silicon, monocrystalline silicon, amorphous silicon, and/or have any suitable crystallinity. The first quantity of silicon material can be an ingot, particles, flakes, and/or have any suitable structure(s).

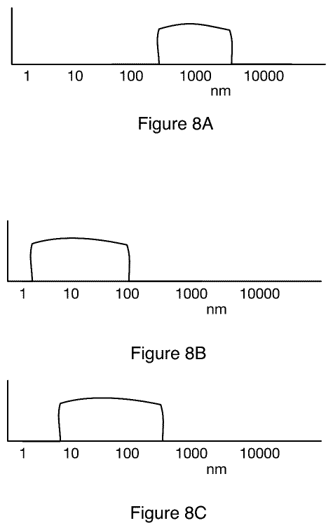

The second quantity of silica preferably includes (e.g., is composed essentially of) silica particles. However, the second quantity of silica can additionally or alternatively include silica films, silica shards, and/or any suitable silica morphology. The silica particles can be silica nanoparticles, silica mesoparticles, silica microparticles, and/or any suitable silica particles. The silica particles can have a spheroidal (e.g., spherical, ellipsoidal, etc.); rod; platelet; star; pillar; bar; chain; flower; reef; whisker; fiber; box; polyhedron (e.g., cube, rectangular prism, triangular prism, etc.); worm-like morphology (e.g., vermiform, etc.); foam-like morphology; an egg-shell-like morphology; have a shard-like morphology; and/or have any suitable morphology. A characteristic size (e.g., mean, median, mode, D50, D10, D90, etc. such as for the radius, diameter, diagonal distance, longest dimension, shortest dimension, average dimension, perimeter, circumference, etc.) of the silica particles is preferably between about 500 nm and 50 μm (as shown for example in FIG. 8A), which can provide a technical advantage of facilitating reduction of the silica particles (e.g., in S300) without significantly degrading the morphology of the particles during the reduction. However, the characteristic size can additionally or alternatively be less than 500 nm (e.g., 1 nm, 2 nm, 5 nm, 10 nm, 20 nm, 50 nm, 100 nm, 150 nm, 200 nm, 500 nm, values or ranges therebetween, as shown for example in FIG. 8B or 8C, etc. which may provide a technical advantage of facilitating production of higher surface area silica and/or silicon compared to other characteristic sizes) and/or greater than 50 μm (e.g., 50 μm, 100 μm, values or ranges therebetween, etc.). The silica particles are preferably porous. However, the silica particles can be hollow, solid, and/or have any suitable structure.

In some variants, the second quantity of silica material can be silica particles with a diameter (e.g., most common diameter, mean diameters, topsize diameter, minimum diameter, etc.) or other characteristic dimension between 1 μm and 50 μm (e.g., 1 μm, 2 μm, 3 μm, 5 μm, 10 μm, 20 μm, 30 μm, 50 μm values or ranges therebetween, etc.). Variations with silica particles with a size comparable to graphite particles (e.g., silica particles with a particle size 10-30 μm, 3-5 μm, 3-30 μm, 3-10 μm, 5-30 μm, etc.) can provide particular technical advantages particularly in applications (e.g., batteries, battery anodes, etc.) that include a combination of graphite and silicon (e.g., silicon derived from the silica). In these variations, the silica particles can be obtained, for instance, by grinding quartz. In these variants, the second quantity of silica preferably has a characteristic size (e.g., diameter) with a narrow distribution such as a variance or standard deviation of the size distribution that is less than about 20% (e.g., 0.1%, 1%, 2%, 5%, 10%, 15%, 22%, etc.) of the mean of the size distribution (e.g., a size distribution with a mean size of 5 μm would have a standard deviation of at most 1 μm). In some examples of these variants, the target silica size and/or size distribution can be achieve by comminuting (e.g., milling, grinding, etc.) the second quantity of silica material.

The second quantity of silica material preferably includes dopant atoms. A preferred dopant concentration (e.g., as a percentage by mass, as an elemental percentage, as a percentage by volume, as a stoichiometric percentage, etc.) is between about 1-20% (e.g., 0.9%, 1%, 2%, 3%, 5%, 7%, 8%, 10%, 12%, 15%, 18%, 20%, 20.5%, values or ranges therebetween) with the remainder as silica and/or SiOₓ. However, the dopant concentration can be less than 1% or greater than 20%. As an illustrative example, the second quantity of silica can include silica that is doped (e.g., homogeneously doped through a volume of the silica, homogeneously doped over a surface of the silica, inhomogeneously doped such as including disparate grains, etc.) with 2-10% (e.g., elemental composition, by mass, etc.) carbon.

In variants, the silica can include a plurality of dopants, where each dopant can have the same or different concentration and doping distribution. In one illustrative example of such a variant, the silica can be doped with carbon and a reducing agent (e.g., magnesium, aluminium, etc.). In another illustrative example of such a variant, the silica can be doped with carbon and lithium. However, the silica can include any suitable dopant(s).

The silica starting material is preferably reduced using a carbothermic reaction. However, the silica starting material can be reduced using plasma reduction, electrochemical reduction, any suitable reduction reaction. The carbothermic reaction is preferably performed at a high temperature (e.g., a temperature greater than a melting point, boiling point, degradation point, etc. of silica and/or silicon), which can be beneficial for forming the second quantity of silica with the desired morphology, facilitate complete reduction of silicon in the first quantity of silicon, can facilitate removal of volatile contaminants, facilitate homogeneous doping of the silica and/or silicon (e.g., by facilitating diffusion of dopants), and/or can provide any suitable technical advantage. For instance, the carbothermic reaction can be performed at or above 2000° C., 2200° C., 2300° C., 2400° C., 2500° C., 2600° C., 2700° C., 2800° C., 2900° C., 2950° C., values or ranges therebetween, and/or at any suitable temperature. However, the carbothermic reaction can be performed at any suitable temperature.

The silica starting material is preferably reduced in the presence of a reducing agent. The reducing agent is preferably a carbonaceous reducing agent (e.g., a reducing agent that includes, consists essentially of, etc. carbon atoms such as graphite, graphene, coke, coal, wood chips, carbon rods, wood, carbide-derived carbon, amorphous carbon, Q-carbon, glassy carbon (e.g., reticulated vitreous carbon), carbon nanofoam, charcoal, carbon black, carbon fiber, activated carbon, soot, and/or any suitable carbon allotrope or compound (e.g., organic or inorganic material). However, the reducing agent can additionally or alternatively include a metallic reducing agent (e.g., magnesium, aluminium, etc.) and/or any suitable reducing agent.

In typical carbothermal reductions, the ratio (e.g., mass ratio, stoichiometric ratio, etc.) of reducing agent to silica depends on a valency of the reducing agent (e.g., the ratio is 1:1 for reducing agents with a valency of 4 such as carbon, is 2:1 for reducing agents with a valency of 2 such as magnesium, is 4:3 for reducing agents with a valency of 3 such as aluminum, etc.). In some variants, however, the ratio of reducing agent to silica is preferably greater than the stoichiometric ratio. These variants can provide a technical advantage for increasing a dopant level, particularly within the second quantity of silica (e.g., silica particles). In a first specific example, when a ratio (e.g., molar ratio, stoichiometric ratio based on the reduction reaction, mass ratio, etc.) of silica to carbonaceous reducing agent is about 1:1, the resulting silica precursors can have a carbon doping between about 0-2%. In a variation of the first specific example, when the ratio of silica to carbonaceous reducing agent is about 1:1.25 (e.g., 1-1.3), the resulting silica precursors can have a carbon doping between about 0.5-8%. In a second variation of the first specific example, when the ratio of silica to carbonaceous reducing agent is about 1:1.5, the resulting silica precursors can have a carbon doping between about 1-10%. In a second specific example, when a ratio of silica to carbonaceous reducing agent in a carbothermal reaction is about 1:2, the resulting silica precursors can have a carbon doping between about 1-50% (e.g., 1%, 2%, 3%, 5%, 7%, 8%, 10%, 12%, 15%, 1-10%, 2-10%, 2-8%, 5-20%, 5-10%, 10-25%, values or ranges therebetween, etc.). In a third specific example, silicon chloride (e.g., SiCl4) and/or other pyrolyzable or hydrolyzeable silicon sources (e.g., silicon tetrabromide; silicon tetraiodide; silicon tetrafluoride; silane; silicon with any combination of 1-4 hydrogen, fluorine, chlorine, bromine, and/or iodine atoms such as silicon trichloride, silicon tribromide, etc.; etc.) can be heated to at most about 2000° C. (e.g., using a flame; such as 1000° C., 1100° C., 1200° C., 1300° C., 1400° C., 1500° C., 1600° C., 1700° C., 1800° C., 1900° C., 2000° C., values or ranges therebetween, etc.) in the presence of an oxidizing agent (e.g., oxygen, water, oxygen and hydrogen, etc.), to form silica fumes. In the third specific example, carbon sources (e.g., graphite; hydrocarbons such as methane, ethane, ethene, ethyne, propane, propene, propyne, etc.; etc.) can be added to dope the formed silica fumes with carbon. In variations of the first, second, and/or third specific examples, the carbothermal reaction can be performed in the presence of a carbonaceous atmosphere (e.g., include vaporized carbon sources such as hydrocarbons), which can modify and/or prepare the target carbon doping. However, the resulting silica precursors can be tuned (e.g., properties such as doped, size, shape, porosity, etc. can depend on) using temperature, time, atmosphere (e.g., atmospheric concentration, pressure, chamber cleaning, etc.), and/or otherwise be tuned and/or vary depending on the carbothermal reaction. Similarly, the amount of carbon could be decreased in the silicon production process to decrease the amount of carbon in the residual silica. As another example, silicon oxides produced as a byproduct in an electric arc furnace can have a higher carbon content based on the amount of carbon (e.g., coal, coke, graphite, etc.) in the furnace (e.g., the ratio of carbonaceous reducing agent to silica, residual carbon deposits that are not removed or not fully removed between carbothermal reactions, etc.). Greater carbon contents generally occur when greater amounts of carbon (for a fixed amount of silicon or silicon oxide) are present. However, the process can otherwise be modified (e.g., change amount of time, change a temperature, change a reagent, etc.).

In a specific example (as shown for instance in FIG. 5), of a carbothermic reaction, silica (e.g., quartz; high quality quartz such as at least 90%, 95%, 97%, 99%, 99.5%, 99.9%, 99.95%, 99.99%, 99.999%, values there between, etc. pure; coesite; stishovite; tridymite; cristobalite; seifertite; amorphous silica; etc.) can be reduced (e.g., at a reducing temperature such as between about 1300° C.-3000° C., etc.) in the presence of a carbonaceous reducing agent (e.g., coat, coke, carbon rods, graphite, wood, etc.). The ratio (e.g., mass ratio, molar ratio, stoichiometric ratio, volume ratio, etc.) of carbonaceous reducing agent to silica can be between about 10:1 and 1:10; however, the ratio can be any suitable value. The carbothermal reaction can additionally or alternatively include any suitable reagents or dopants (e.g., iron to form ferrosilicon, lithium to form lithiated silicon, etc.). During this process, some of the starting silica material can vaporize and thereafter condense (e.g., on cooler regions within the reaction vessel, in a collection vessel, in a collection region, etc.; for instance after being filtered in a filter such as a baghouse filter) forming silica particles (e.g., silica fumes, fumed silica, etc.) that can be used as a silica precursor (e.g., in S300), where the silica particles can include carbon doping (and/or other dopants such as iron, lithium, etc.). The ratio and/or the amount of carbon added in the carbothermal reduction can be used to tune the amount of carbon in the silica precursor (e.g., the collected silica fumes, silica material as used in S300, etc.). The silica particles can have a chemical formula such as SiO₂Cₓ, (SiO₂)Cₓ, SiO_{y}CₓSiO₂₍₁₋ₓ₎Cₓ(e.g., x can be any value or range between about 0 and 1, y can be any suitable value or range between 0 and 2, etc.), and/or can have any suitable chemical formula.

The furnace used in S200 preferably includes a collection region, where the collection region is at a lower temperature than the reaction region of the furnace (e.g., at a temperature where silica reduction using carbon is negligible). The second quantity of silica preferably collects (e.g., deposits, forms, etc.) within the collection region. For example, the collection region can be at a temperature less than about 1500° C. (e.g., 100° C., 200° C., 500° C., 750° C., 1000° C., 1250° C., etc.). However, the collection region can be at any suitable temperature. However, the collection region can recover the silicon (e.g., first quantity of silicon) and/or any suitable material. However, the furnace may not include a collection region (e.g., an exhaust, output port, wall, etc. can be act as a collection region, can release one or both of the silica and silicon, etc.).

Reducing the silica particles S300 preferably functions to reduce the second quantity of silica (e.g., recovered from S200, as shown for example in FIG. 5) to silicon particles. S300 is typically performed in a separate chamber (e.g., furnace) from S200. However, S300 can be performed in the same chamber (e.g., furnace) as S200.

In some variants of the method, S300 can be performed in isolation from S200 (e.g., silica particles or other suitable silica precursors can be provided and directly reduced to form silicon particles). In these variants, examples of silica particle precursors can include: sol-gel silica (e.g., silica prepared according to the Stöber method), fume silica, diatoms, glass, quartz, fumed silica, silica fumes, Cabosil fumed silica, aerosil fumed silica, sipernat silica, precipitated silica, silica gels, silica aerogels, decomposed silica gels, silica beads, silica sand, silica dust, waste or residual silica resulting from silcon alloy formation (e.g., waste material produced during alloying of silicon, ferrosilicon, etc.; silicon alloying; silica alloying; etc. such as waste silica resulting from alloying silicon produced in S200), and/or any suitable silica particles.

During and after the reduction of the silica particles the dopant distribution within the silicon particles is preferably the same as the distribution of the dopants of the silica material (e.g., silica particles). For example, when the dopants are homogeneously distributed within the silica particles, the dopants are homogeneously distributed within the silicon particles. However, the reduction process can change the dopant distribution. In a specific example, carbon dopants can be distributed throughout the silicon structure. For instance, the carbon dopants (and/or any suitable dopants) can be internally homogeneously distributed and/or distributed on an external surface of the silicon particles. Dopants (e.g., carbon dopants) exposed to the external surface can provide a technical advantage of improving silicon material coating (e.g., carbon coating) by acting as favorable reaction and/or deposition sites. A homogenous dopant distribution in the silicon particles is preferred, but an inhomogeneous dopant distribution can be formed.

S300 is preferably performed at a low temperature (below a melting, vaporization, degradation, etc. temperature of silica and silicon such as less than 1000° C.). Maintaining the low temperature can be beneficial for preserving a morphology of the silica particles in the resulting silicon particles. However, S300 can be performed at a high temperature (e.g., where the particles are exposed to the high temperature for a brief duration of time to minimize particle morphology changes) such as at a temperature greater than 1000° C., ≥1500° C., ≥2000° C., ≥3000° C., and/or any suitable temperature.

In a first variant, reducing the silica precursor can be performed as and/or include any steps as disclosed in U.S. patent application Ser. No. 17/322,487 titled ‘POROUS SILICON AND METHOD OF MANUFACTURE’ and filed 17 May 2021 or U.S. patent application Ser. No. 17/525,769 titled ‘SILICON MATERIAL AND METHOD OF MANUFACTURE’ filed 12 Nov. 2021, each of which is incorporated in its entirety by this reference. However, reducing the silica precursor can be performed in any manner.

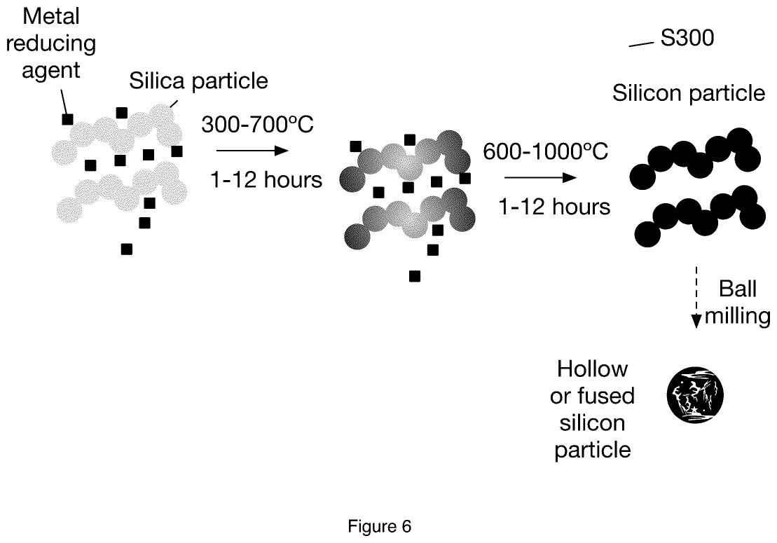

As an illustrative example, reducing the doped silica particles can include: mixing the silica precursor with a salt (e.g., sodium chloride), mixing the silica particles with a reducing material (e.g., magnesium, aluminium, etc.), and heating the silica particles to a reduction temperature (e.g., 500° C., 600° C., 700° C., 800° C., 900° C., 1000°, 1200° C., temperatures therebetween, etc.) for between 1-24 hours. In variants of this illustrative example (as shown for instance in FIG. 6), the silica particles can be heated to one or more intermediate temperatures (e.g., a temperature below the reduction temperature; 200° C., 250° C., 300° C., 400° C., 500° C., 600° C., 700° C., values therebetween, etc.; etc.) for an amount of time (e.g., 30 minutes to 24 hours) before heating the silica particles to the reduction temperature (e.g., reducing temperature). Note that an intermediate temperature can be but does not have to be a fixed temperature (e.g., or fluctuations about a fixed temperature such as stabilized by a PI, PID, PD, etc. controller). For example, an intermediate temperature could additionally or alternatively be a duration of time with a low ramp rate (e.g., <1° C./min) relative to a normal ramp rate used to achieve the target reducing temperature. However, the silica precursor can otherwise be reduced.

In a second variant (that can be combined with and/or separate from the first variant), the silica particles can be reduced by milling and/or comminution. For example, ball milling (or other comminution processes such as grinding) can result in local heating high enough to locally melt a reducing agent (e.g., magnesium) enabling the reducing agent to diffuse into the silica and reduce the silica. The milling rate can depend on the mill, jar size, milling medium, fill ratio, milling time, silica material structure, whether the silica is milled continuously, a local temperature, a local heating rate, and/or other properties of the mill and/or silica material. The milling rate is preferably close to the lowest milling rate that can result in melting of the reducing agent (which can be beneficial for generating a lower local heating effect, result in a higher porosity silicon material, etc.). Similarly, too high of a milling rate can result in trapped silica and/or oxygen within the silicon (e.g., within pores of the silicon) that can lead to dangerous reaction conditions (e.g., explosions due to pressure release, exothermic reaction between silica and reducing agent, etc.). For example, a milling rate of 200 rpm can be too low to initiate the reduction, whereas a milling rate of 300-400 rpm (or higher) can enable the milling to occur (and milling rates greater than about 700-900 rpm can lead to incomplete reduction and/or trapped reagents). In another example, the milling rate and/or time can be chosen to avoid trapping oxygen, silica, magnesium (e.g., MgSi, MgO, etc.), and/or other species within the silica (such as within a hollow cavity of a silicon material where they can be difficult to remove or wash). However, any suitable milling rate can be used.

The milling speed (e.g., comminution speed) is preferably a value or range between about 1-2500 rpm (e.g., 100, 200, 300, 400, 500, 600, 700, 800, 900, 1000, 1200, 1500, 1750, 2000, 2500, values or ranges therebetween, etc.), but less than 1 rpm or greater than 2500 rpm. The milling time (e.g., comminution time) is preferably an amount or range of time between 1 min and 1000 hours (such as 1-24 hours), but can be less than 1 min or greater than 1000 hours. The milling time can be a contiguous milling time (e.g., a continuous milling time), a total milling time (e.g., including time spent not milling the material such as to allow the material to cool), a total amount of time that the mill is operable for (e.g., an amount of time that does not include periods of time that the mill is not operating), and/or any suitable time. The comminution container 400 (e.g., milling container) can be made of or include: steel, including hardened steel, tool steel, hardened chromium steel, tempered steel, stainless steel, tungsten carbide cobalt (WC—Co), WC-lined steel, bearing steel, copper, titanium, sintered corundum, yttria-stabilized zirconia (YSZ), sapphire, agate, hard porcelain, silicon nitride (e.g., Si₃N₄), and/or any suitable materials. The volume of the comminution container is preferably filled (e.g., with grinding medium, with powder, with additives, etc.) to a value or range between about 1-99% (e.g., 50%) of the total volume of the milling container (also referred to as the volume ratio of the comminution container). However, the milling container can be less than 1% or greater than 99% filled. The milling medium (e.g., comminution medium, milling medium, grinding medium, etc.) can be made of or include: hardened steel, tool steel, hardened chromium steel, tempered steel, stainless steel, tungsten (W), tungsten carbide (WC), tungsten carbide-cobalt (WC—Co), WC-lined steel, bearing steel, copper (Cu), titanium (Ti), sintered corundum, yttria-stabilized zirconia (YSZ), sapphire, agate, hard porcelain, silicon nitride (Si₃N₄), and/or any suitable material(s). The comminution container (e.g., milling container) can be made of or include: steel, including hardened steel, tool steel, hardened chromium steel, tempered steel, stainless steel, tungsten carbide cobalt (WC—Co), WC-lined steel, bearing steel, copper, titanium, sintered corundum, yttria-stabilized zirconia (YSZ), sapphire, agate, hard porcelain, silicon nitride (e.g., Si₃N₄), and/or any suitable materials. The comminution temperature (e.g., milling temperature) is preferably between about −200° C. (e.g., cryogenic milling) to 200° C., but the milling temperature can be less than −200° C. or greater than 200° C.

In the second variant, the silica material and reducing agent are preferably intermittently milled (e.g., milled for a predetermined amount of time interspersed with periods of time where the silica material is not milled or milled at a lower milling rate). Intermittent milling can have an additional technical advantage of enabling higher milling rates to be used (e.g., before potentially dangerous conditions are experienced). Each period of milling can have the same milling conditions (e.g., same milling speed) or different milling speeds (e.g., according to a milling speed schedule, according to a milling ramp up, according to a milling ramp down, etc.). Intermittent milling can be beneficial for driving the reduction to completion and/or improving a homogeneity of the reduction (e.g., as the milled silica has the opportunity to cool between milling, by allowing the silica and/or silicon to settle between impact occurrences, etc.).

During intermittent milling, the duty cycle is typically about 50% (e.g., milled for approximately the same length of time as not milled). However, the duty cycle can be less than 50% (e.g., milled for less time than the material is not milled such as mill for 1 minute and not milled for 2 minutes) and/or greater than 50% (e.g., milled for greater time than the material is not milled for such as milled for 2 minutes and not milled or resting for 1 minute). The active milling time and the rest time are typically between about 1 minute and 15 minutes. However, the active milling time and the rest time can be less than 1 minute and/or greater than 15 minutes.

The silica particles can be comminuted with one or more additional materials (e.g., dopant sources) which can function to dope the silica particles and/or resulting silicon. For instance, carbonaceous materials (e.g., polymers, graphite, graphene, carbon nanotubes, etc.) can be comminuted with the silica particles.

Comminuting the silica particles can additionally or alternatively function to control (e.g., tune, modify, change, reduce, increase, etc.) a particle size (e.g., minimum particle size such as a D1, D3, D5, D10, etc. particle size; topsize such as a D90, D95, D97, D99, etc. particle size; an average or D50 particle size; a particle size distribution; etc.) and/or particle morphology (e.g., improve a homogeneity of particle shape, decrease an ellipticity of particles, decrease an eccentricity of particles, increase a particle sphericity, bring a particle compactness closer to a spherical compactness, etc.). For instance, comminuting the silica particles can function to prepare a silica sample with more homogeneous particle size (e.g., a narrow particle size distribution). However, comminuting the silica particles can additionally or alternatively function.

However, the silica material and reducing agent can be continuously milled and/or milled in any manner.

The extent of the silica reduction can be controlled by the amount (e.g., relative amount to the silica) of reducing agent added, by the comminution parameters (e.g., speed, fill volume percentage, duration, etc.), and/or based on any suitable parameters. For instance, a higher oxygen content in the resulting silicon material can be achieved using less reducing agent (e.g., 50%, 70%, 80%, 90%, etc. reducing agent to silica by stoichiometric percent). The reducing agent can be added all at once and/or sequentially. Sequential addition can be beneficial for improving a homogeneity of the silica reduction (e.g., more homogeneous silicon can be formed, the silicon can more accurately retain a structure of the silica particles, etc.). As an illustrative example, 1 g SiO₂ can be fully reduced with 0.81 g Mg. In this illustrative example, 0.2 g Mg can be added each time with milling at 400 rpm-500 rpm for 10 min before the next aliquot of Mg is added. However, any suitable aliquot(s) can be added.

During silica particle reduction, the atmosphere can be inert (e.g., including nitrogen, helium, neon, argon, krypton, xenon, radon, or other substantially inert gases; vacuum; etc.), oxidizing (e.g., include oxygen such as to promote formation of an oxide layer), include one or more dopants (e.g., boron, phosphorous, germanium, arsenic, aluminium, gallium, indium, antimony, bismuth, lithium, nitrogen, gold, platinum, etc. such ad to dope, modify a carrier population, modify an electrical conductivity, etc.), reducing atmosphere (e.g., include gaseous reducing agents), and/or can be any suitable atmosphere. The atmosphere (e.g., environment) can be controlled based on a gas flow, gas pressure, and/or using any suitable control.

In some variations (particularly of the second variant, but that can be applied in combination with the first variant and/or used in any manner) the milling and/or comminution can additionally (or alternatively) be used to fuse the silica and/or resulting silicon material (e.g., function to modify the morphology, structure, porosity, density, etc. of the resulting silicon material relative to the starting silica material). For example, the silicon material can be cold welded (e.g., to form hollow particles with smaller external surface areas than internal surface areas, to fuse separate particles together, etc.) by the comminution and/or reduction process (e.g., as disclosed in U.S. patent application Ser. No. 17/824,627 titled ‘SILICON MATERIAL AND METHOD OF MANUFACTURE’ filed 25 May 2022 which is incorporated in its entirety herein). Variations of the second variant can be performed without using doped silica (e.g., silica that does not include carbon can reduced according to the second variant).

In some variants, the properties and/or settings of reducing the silica precursor can be selected and/or modified based on the dopant properties (e.g., type, concentration, distribution, etc.). As an illustrative example, the reduction temperature, ramp rate, and/or intermediate temperature (e.g., number of intermediate temperature steps, duration that the material remains at an intermediate temperature, intermediate temperatures, etc.) can depend on the doping concentration (e.g., as carbon dopants can result in additional local heating proximal the carbon dopants because of differences in thermal properties of carbon relative to silicon). For instance, when silica particles have a 10% dopant concentration, more (e.g., three or more intermediate temperatures) and/or longer (e.g., 1-12 hours) intermediate temperatures and/or a lower final reducing temperature (e.g., 850° C. rather than 900° C.) can be used compared to silica particles with a 2% dopant concentration (e.g., with one or two intermediate temperatures, intermediate temperature durations between 0.5-8 hours, etc.). However, the properties and/or settings can be independent of the dopant properties.

Processing the silicon S400 preferably functions to prepare the silicon for one or more application. Examples of processing the silicon can include: washing the silicon (e.g., liquid phase wash such as using a solvent, acid, surfactant, etc.; gas phase wash such as using gaseous reagents, gaseous acids such as HCl, etc.; etc.), doping the silicon with dopant(s), fusing the silicon (e.g., comminuting the silicon, milling the silicon, heating the silicon, etc.), coating the silicon (e.g., with a carbon coating, with a polymer coating such as PAN, with a coating as disclosed in or in a manner as disclosed in U.S. Patent Application Ser. No. 17/890,863 titled ‘SILICON MATERIAL AND METHOD OF MANUFACTURE’ filed 18 Aug. 2022 which is incorporated in its entirety by this reference, etc.), cyclizing a coating, carbonizing a coating (e.g., by heating to above a carbonizing temperature such as 500° C.), oxidizing the silicon (e.g., by exposing the material to oxygen, water, etc.; by heating the material in an oxidizing environment; etc.; which can provide a technical advantage of increasing a material stability), dispersing the silicon material in a solvent (e.g., water, alcohol(s), etc.; with binder, conductive material, etc.), and/or any suitable steps.

The silicon can be doped with dopants (e.g., carbon, boron, phosphorous, transition metals, etc.) and/or stabilizing agents (e.g., oxygen) in a manner as described for the silica precursor (e.g., using any doping process as discussed above). However, the silicon can be doped with dopants in any manner.

In some variants of the method, particularly but not exclusively when a furnace or chamber is used for multiple instances of the method or steps thereof with different starting materials (e.g., S200 is repeated for with additional silica starting material, S300 is repeated with additional silica particles, etc.), the method can include not cleaning or washing the furnace between different instances and/or repetitions of the method. In particular, excess dopants (e.g., dopant deposits) within the furnace and/or chamber may not be removed from. As an illustrative example, S200 can include collecting (e.g., physically collecting such as via scraping, grinding, milling, pouring, dispensing, etc.) silica particles (e.g., fumed silica, second quantity of silica, etc.) and/or silicon (e.g., melted silicon, silicon ingot, first quantity of silicon etc.) from the furnace without thoroughly washing (e.g., chemically, abrasively, double washing, triple washing, using varying polarity solvents, etc.) the furnace (e.g., without using solvents, acids, bases, etchants, surfactants, chelating agents, etc. to dissolve, dislodge, remove, etc. dopants from the furnace). In variations of this illustrative example, S300 can include collecting silicon particles from the furnace without thoroughly washing the furnace. In another variation of this specific example, the furnace (e.g., as used in S200 or S300) can be washed using one or more etchants (e.g., hydrochloric acid such as gaseous HCl or aqueous HCl, sulfuric acid, nitric acid, hydrofluoric acid, hydrobromic acid, aqua regia, etc.) to remove metals (e.g., trace elements, impurities, etc. originally present in the silica starting material such as iron, nickel, sodium, potassium, magnesium, aluminium, manganese, nitrogen, sulfur, etc.) without substantially removing carbon (e.g., leaving greater than about 90% of carbon deposits within) from the furnace or chamber. However, the method can include thoroughly washing the furnace (e.g., after a predetermined number of method instances, on a wash schedule, when a dopant concentration exceeds a threshold dopant concentration, etc.) and/or can include any suitable washing process(s).

The methods of the preferred embodiment and variations thereof can be embodied and/or implemented at least in part as a machine configured to receive a computer-readable medium storing computer-readable instructions. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A method comprising: reducing a silica starting material in a furnace to produce silicon with an elemental purity of about 99% and silica fumes comprising between 2-10% carbon by mass and 90-98% silica by mass, wherein the silica starting material is reduced in the presence of a carbonaceous reducing agent, wherein the furnace is not cleaned between reducing the silica starting material and reducing a second silica starting material.

2. The method of claim 1, wherein the furnace comprises an electric arc furnace.

3. The method of claim 1, wherein reducing the silica starting material comprises heating the silica starting material to a temperature between 2200° C. and 3000° C.

4. The method of claim 1, further comprising removing metal contaminants from the chamber without removing carbonaceous material build-up from the chamber.

5. The method of claim 4, wherein removing metal contaminants comprises exposing the chamber to gaseous hydrochloric acid.

6. The method of claim 1, wherein the silica fumes comprise spheroidal particles with a diameter between about 500 nm and 5 μm.

7. The method of claim 1, wherein an excess of carbonaceous reducing agent relative to the silica starting material is used.

8. The method of claim 1, wherein the silica precursor comprises sand, quartz, quartzite, or fulgurite.

9. The method of claim 1, wherein the carbonaceous reducing agent comprises graphite.

10. The method of claim 1, further comprising introducing a gaseous carbon source comprising at least one of methane, ethane, ethene, or ethyne into the chamber contemporaneously with reducing the silica starting material.

11. The method of claim 1, further comprising, reducing the silica fumes to form a porous silicon material by heating the silica fumes to a temperature between about 500-900° C. in the presence of a metal reducing agent.

12. The method of claim 11, wherein heating the silica fumes comprises locally heating the silica fumes by ball milling the silica fumes.
